(19) United States
(12) Patent Application Publication
(10) Pub. No.: US 2004/0236670 A1
(43) Pub. Date: Nov. 25, 2004

(54) Translation service auction system, method and program

(75) Inventor: Kazuhiro Hara, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/847,345

(22) Filed: May 18, 2004

(30) Foreign Application Priority Data
May 19, 2003 (JP) 2003-140074

(51) Int. Cl. G06F 17/60

(52) U.S. Cl. 705/37

(57) ABSTRACT

The invention provides a translation service auction system and method by which a translation request member can access actual results of translation of translation contract members to select a contract member having a reliable translation skill and actual results. A terminal of a member who tries to request translation transmits translation request information to a data server. The data server receives the translation request information and presents an advertisement of it on a network. Each of terminals of members who try to contract the translation refers to the translation request information advertisement and transmits a translation contract desire to the data server. The data server downloads a sample manuscript to the contract member terminals. The members of the contract member terminals would translate the sample manuscript and transmit their translations to the translation request terminal and the data server. The member of the translation request terminal would compare the received translations of the sample manuscript to select a translation contract member. The selected translation contract member would receive an adoption notification from the translation request terminal, complete a translation of the manuscript within a predetermined term and transmit the translation to the translation request terminal.

### BACKGROUND OF THE INVENTION

1. Field of the Invention

The present invention relates to a translation service auction system, method and program for providing a server of translation, and more particularly to a translation service auction system, method and program by which an optimum translation contractor can be selected based on actual results of translation contractors.

2. Description of the Related Art

In a conventional translation service system, a contractor suitable for contents of a request of a client is selected and mediated.

A mediation apparatus and method is disclosed in Japanese Patent Laid-Open No. 2002-279219 (hereinafter referred to as Patent Document 1). In the mediation apparatus and method, a mediation server calculates similarities between request information and translation and correction information and transmits the request information to a server of a contractor who exhibits the highest similarly. Then, the mediation server transmits tentative request acceptance information from the contractor server based on the request information and the contraction selection result to the client server. Further, the mediation server transmits formal request information based on the tentative request acceptance information and the contractor selection result to the contractor server. Thus, translation and correction information is provided from the contractor server to which the request has been issued with the formal request information.

However, the mediation apparatus and method disclosed in the Patent Document 1 has the following problem.

In particular, since a translation contractor is selected based on a criterion of a mediator, it is suspect that a translation contractor optimum to contents of a request is selected.

### SUMMARY OF THE INVENTION

It is an object of the present invention to provide a translation service auction system, method and program by which a contractor optimum to contents of a request can be selected by a client of the client.

In order to attain the object described above, according to an aspect of the present invention, there is provided a translation service auction system, comprising a data server, a translation request member terminal connected to the data server through a network and including translation requesting means for transmitting translation request information to the data server through the network, and a plurality of translation contract member terminals connected to the data server and the translation request member terminal through the network, the data server including translation request information reception means for receiving the translation request information from the translation request member terminal and translation request advertisement presentation means for presenting a translation request advertisement on the network based on the received translation request information, each of the translation contract member terminals including translation desire transmission means for referring to the translation request advertisement presented by the data server and transmitting a translation contract desire to the data server, the data server further including translation desire reception means for receiving the translation contract desire from any of the translation contract member terminals and sample manuscript transmission means for transmitting a sample manuscript based on the translation request information to those of the translation contract member terminals from which the translation contract desire is received, each of the translation contract member terminals further including sample translation means for receiving and translating the sample manuscript from the data server and transmitting a result of the translation of the sample manuscript to the translation request member terminal, the translation request member terminal further including contract selection means for receiving the translation result of the sample manuscript from any of the translation contract member terminals, comparing the received translation results of the sample manuscript to determine a particular one of the translation contract member terminals which should be adopted, transmitting an adoption notification to the particular translation contract member terminal and transmitting a notification of the adopted translation contract member terminal to the data server, the data server further including contract result reception means for receiving the notification of the adopted translation contract member terminal from the translation request member terminal and request manuscript transmission means for transmitting a request manuscript based on the translation request information to the adopted translation contract member terminal, each of the translation contract member terminals further including request manuscript translation means for receiving the request manuscript from the data server and the adoption notification from the translation request member terminal, translating the request manuscript and transmitting a result of the translation of the request manuscript to the translation request member terminal, the translation request member terminal further including translation result reception means for receiving the result of the translation of the request manuscript from the adopted translation contract member terminal.

The translation request member terminal may further include translation result transmission means for transmitting a satisfaction degree of the result of the translation of the requested manuscript to the data server, and the data server may further include presentation means for presenting the satisfaction degree of the result of the translation of the request manuscript transmitted from the translation request member terminal while reflecting the satisfaction degree in actual results of translation of the adopted translation contract member. The contract selection means of the translation request member terminal may compare the results of the translation of the sample manuscript and refer to the actual results of the translation of the pertaining translation contract members to decide a translation contract member terminal to be adopted.

Each of the translation contract member terminals may further include money receipt completion notification means for transmitting a notification of completion of receipt of money from the translation request member to the data server, and the data server may further include presentation means for presenting the notification of completion of receipt of money from the translation request member received from the translation contract member terminal while reflecting the notification in actual results of receipt of money from the translation request member. The translation contract member terminal may further include translation decision means for referring to the actual results of receipt of money of the translation request member to decide whether or not the translation request should be undertaken.

According to another aspect of the present invention, there is provided a translation service auction method for a translation service auction system wherein a data server, a translation request member terminal and a plurality of translation contract member terminals are connected to each other by a network, comprising a step performed by the translation request member terminal of transmitting translation request information to the data server, a step performed by the data server of receiving the translation request information from the translation request member terminal and presenting translation request advertisement on the network, a step performed by any of the translation contract member terminals of referring to the translation request information presented by the data server, transmitting a translation contract desire to the data server and transmitting a result of translation of a sample manuscript received from the data server to the translation request member terminal, a step performed by the translation request member terminal of receiving and comparing the results of the translation of the sampling manuscript from the translation contract member terminals to decide a translation contract member terminal to be adopted and issuing an adoption notification to the adopted translation contract member terminal, a step performed by the adopted translation contract member terminal of receiving the adoption notification from the translation request member terminal and transmitting a result of translation of the requested manuscript to the translation request member terminal, and a step performed by the translation request member terminal of receiving the result of the translation of the requested manuscript from the adopted translation contract member terminal.

The translation request member terminal may transmit a satisfaction degree of the result of the translation of the requested manuscript to the data server, and the data server may present the satisfaction degree of the result of the translation of the requested manuscript received from the translation request member terminal while reflecting the satisfaction degree in actual results of translation of the adopted translation contract member. The translation request member terminal may compare the results of the translation of the sample manuscript and refers to the actual results of translation of the translation contract member terminals to decide a translation contract member terminal to be adopted.

The adopted translation contract member terminal may issue a notification of completion of receipt of money from the translation request member to the data server, and the data server may present the notification of completion of receipt of money from the translation request member received from the adopted translation contract member terminal while reflecting the notification in actual results of receipt of money from the translation request member. The translation contract member terminal may refer to the actual results of receipt of money of the translation request member to decide whether or not the translation request should be undertaken.

According to a third aspect of the present invention, there is provided a translation service auction program for a translation service auction system wherein a data server, a translation request member terminal and a plurality of translation contract member terminals are connected to each other by a network, the translation service auction program causing a computer to implement a function of causing the translation request member terminal to transmit translation request information to the data server, a function of causing the data server to receive the translation request information from the translation request member terminal, function of causing the data server to present translation request advertisement on the network, a function of causing any of the translation contract member terminals to refer to the translation request information presented by the data server, transmit a translation contract desire to the data server and transmit a result of translation of a sample manuscript received from the data server to the translation request member terminal, a function of causing the translation request member terminal to receive and compare the results of the translation of the sampling manuscript from the translation contract member terminals to decide a translation contract member terminal to be adopted, a function of causing the translation request member terminal to issue an adoption notification to the adopted translation contract member terminal, a function of causing the adopted translation contract member terminal to receive the adoption notification from the translation request member terminal and transmit a result of translation of the requested manuscript to the translation request member terminal, and a function of causing the translation request member terminal to receive the result of the translation of the requested manuscript from the adopted translation contract member terminal.

The translation service auction program may further cause the computer to implement a function of causing the translation request member terminal to transmit a satisfaction degree of the result of the translation of the requested manuscript to the data server, and a function of causing the data server to present the satisfaction degree of the result of the translation of the requested manuscript received from the translation request member terminal while reflecting the satisfaction degree in actual results of translation of the adopted translation contract member. The translation service auction program may further cause the computer to implement a function of causing the translation request member terminal to compare the results of the translation of the sample manuscript and refer to the actual results of translation of the translation contract member terminals to decide a translation contract member terminal to be adopted.

The translation service auction program may further cause the computer to implement a function of causing the adopted translation contract member terminal to issue a notification of completion of receipt of money from the translation request member to the data server, and a function of causing the data server to present the notification of completion of receipt of money from the translation request member received from the adopted translation contract member terminal while reflecting the notification in actual results of receipt of money from the translation request member. The translation service auction program may further cause the computer to implement a function of causing the translation contract member terminal to refer to the actual results of receipt of money of the translation request member to decide whether or not the translation request should be undertaken.

The translation service auction system, method and program are advantageous in that an optimum translation service can be enjoyed. The reason is that a translator is selected based on comparison of results of translation of a sample manuscript by various translation contractors.

The translation service auction system, method and program are advantageous also in that a request for transmission can be issued to a translator even if the translator is at a remote place. The reason is that the client or translation request member and the translator can communicate with each other through the network.

The translation service auction system, method and program are advantageous further in that the system manager can expect increase of the income of member fees and increase of the income of advertisements as increase of members. The reason is that the member fee can be received the members and the charge for an advertisement can be received.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1(A) is a block diagram showing a configuration of a translation service auction system to which the present invention is applied;

FIG. 1(B) is a block diagram showing a configuration of a data server shown in FIG. 1(A);

FIG. 1(C) is a block diagram showing a configuration of a member A terminal shown in FIG. 1(A);

FIG. 1(D) is a block diagram showing a configuration of a member B terminal shown in FIG. 1(A); and

FIGS. 2 and 3 are flow charts illustrating operation of the translation service auction system of FIG. 1(A).

### DESCRIPTION OF THE PREFERRED EMBODIMENT

A translation service auction system to which the present invention is applied is generally configured such that a member (translation request member) who requests translation presents a sample manuscript and each of members (translation contract members) who try to contract the requested translation transmits a result of translation of the sample manuscript to the translation request member, and the translation request member compares the received results of translation of the sample manuscript to select the translation contract member to whom the translation is to be requested.

More particularly, the translation request member transmits a manuscript, a language into which the sample manuscript is to be translated, a desired date and hour of completion of the translation and so forth to a server of a system manager. The system manager receives the data transmitted from the translation request member and presents the data in a site on the server to disclose the data to the translation contract members. Any of the translation contract members presents a result of translation of the sample manuscript, a translation fee, an estimated date and hour of completion of translation and other necessary information to the translation request member. The translation request member compares the translation contents of the sample manuscript, translation fees, information of the date and hour of completion of translation and other necessary information received from the translation contract members to select a translation contract member whose translation contents of the sample manuscript and so forth satisfy the term and the conditions of the translation request member.

Now, a configuration of a translation service auction system to which the present invention is applied is described with reference to the drawings.

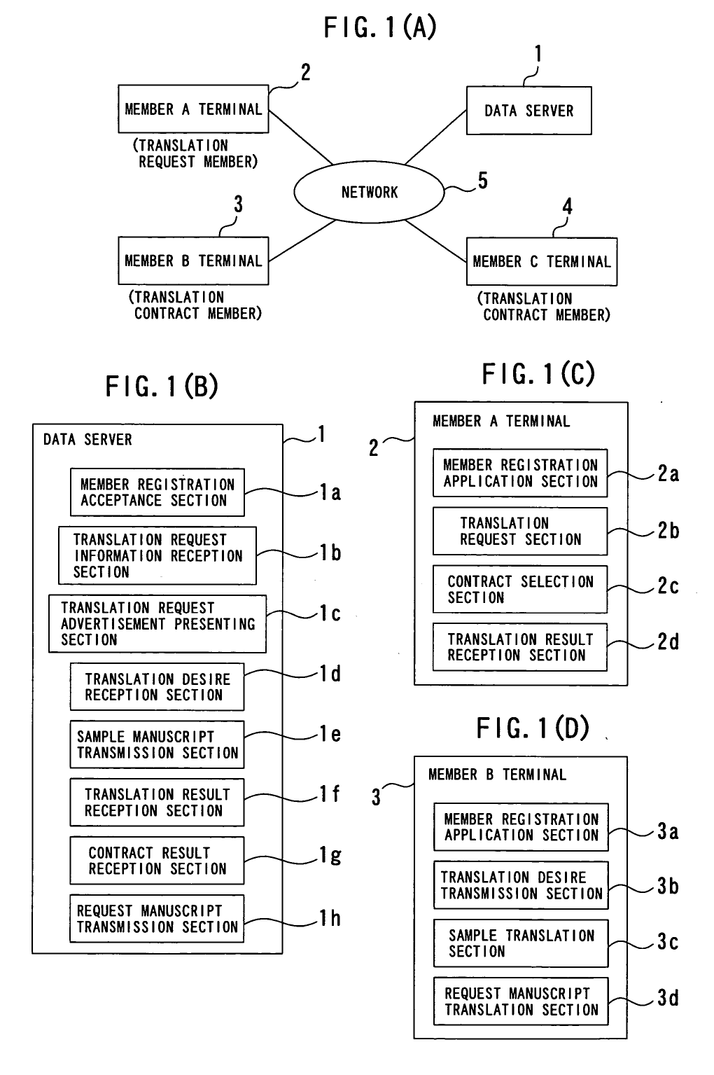

Referring first to FIG. 1(A), the translation service auction system of the present embodiment includes a data server 1, a member A terminal 2, a member B terminal 3, a member C terminal 4, and a network 5. It is to be noted that, in the present embodiment, the member A terminal 2 is assumed to be a terminal of a member who requests translation, and the member B terminal 3 and the member C terminal 4 are assumed to be terminals of members who contract translation. While three member terminals are indicated in FIG. 1(A), there is no limitation to the number of member terminals. Further, while one terminal of the translation request member and two terminals of the translation contract members are indicated in FIG. 1(A), there is no limitation to the numbers of terminals of translation request members and translation contract members.

The data server 1 is an information processing apparatus managed by a translation service providing company and operates under the control of a program. As shown in FIG. 1(B), the data server 1 presents a personal translation service site on the network 5 and includes a member registration acceptance section 1a, a translation request information reception section 1b, a translation request advertisement presenting section 1c, a translation desire reception section 1d, a sample manuscript transmission section 1e, a translation result reception section 1f, a contract result reception section 1g, and a request manuscript transmission section 1h.

The member registration acceptance section 1a receives a member registration application from a member terminal and performs a member registration process, and transmits login information (an ID, a password and so forth) to the terminal registered as a member. It is to be noted that the members are classified into two kinds including those members (translation request members) who request translation and those members (translation contract members) who contract translation.

The translation request information reception section 1b receives a manuscript, a language into which the manuscript is to be translated, desired completion date and so forth (translation request information) from the member A terminal 2. The translation request advertisement presenting section 1c presents a translation request advertisement in the personal translation service site so that the translation request advertisement can be read from the member B terminal 3 and the member C terminal 4. The translation desire reception section 1d receives a translation desire from the member B terminal 3 or/and the member C terminal 4. The sample manuscript transmission section 1e transmits a sample manuscript (first paragraph of the manuscript) to the member B terminal 3 or/and the member C terminal 4. The translation result reception section 1f receives results of translation of the sample manuscript from the member B terminal 3 or/and the member C terminal 4. The contract result reception section 1g receives a result of selection of a translation contract member from the member A terminal 2. The request manuscript transmission section 1h transmits the request manuscript to the terminal of the selected member.

The member A terminal 2 is an apparatus (translation request member terminal) such as a personal computer used by the member A who requests translation, and operates under the control of a program. As shown in FIG. 1(C), the member A terminal 2 includes a member registration application section 2a, a translation request section 2b, a contract selection section 2c, and a translation result reception section 2d.

The member registration application section 2a accesses the member registration acceptance section 1a of the data server 1 to transmit an application of member registration and receives login information (an ID, a password and so forth).

The translation request section 2b accesses the translation service site of the data server 1 to input the login information, and after it is authenticated, the translation request section 2b transmits translation request information necessary for requesting translation.

The contract selection section 2c receives results of translation of a sample manuscript from the member B terminal 3 or/and the member C terminal 4 and compares the results of the translation with each other to select a translation contract member, and transmits a result of the selection to the data server 1 and the terminal of the selected member (here, it is assumed that the translation contract member B is selected).

The translation result reception section 2d receives a result of translation of the full-text of the requested manuscript from the member B terminal 3 and transmits a satisfaction degree of the result of the translation, and performs settlement of the translation charge (remits the translation charge) between the translation result reception section 2d itself and a designated account of the translation contract member B.

The member B terminal 3 is an apparatus (translation contract member terminal) such as a personal computer used by the member B who contracts translation, and operates under the control of a program. As shown in FIG. 1(D), the member B terminal 3 includes a member registration application section 3a, a translation desire transmission section 3b, a sample translation section 3c, and a request manuscript translation section 3d.

The member registration application section 3a accesses the member registration acceptance section 1a of the data server 1 to transmit an application for member registration and receives login information (an ID, a password and so forth).

The translation desire transmission section 3b accesses the translation service site of the data server 1 to transmit the login information, and after it is authenticated, the translation desire transmission section 3b reads the translation request advertisement and transmits a translation desire.

The sample translation section 3c receives a sample manuscript from the data server 1 and transmits a result of translation of the sample manuscript to the data server 1 and the member A terminal 2.

The request manuscript translation section 3d receives the full-text of the requested manuscript from the data server 1 and transmits a result of translation of the full-text of the requested manuscript to the member A terminal 2. Then, the request manuscript translation section 3d confirms settlement of the translation charge between the translation contract member B and the translation request member A, and thereafter issues a notification of completion of receipt of the money and ending of the work to the data server 1.

The member C terminal 4 is an apparatus (translation contract member terminal) such as a personal computer used by the member B who contracts translation, and operates under the control of a program similarly to the member B terminal 3.

The network 5 is a communication network such as the Internet, and connects the data server 1, the member A terminal 2, the member B terminal 3 and the member C terminal 4 to each other.

Next, operation of the translation service auction system of the embodiment of the present invention is described in detail.

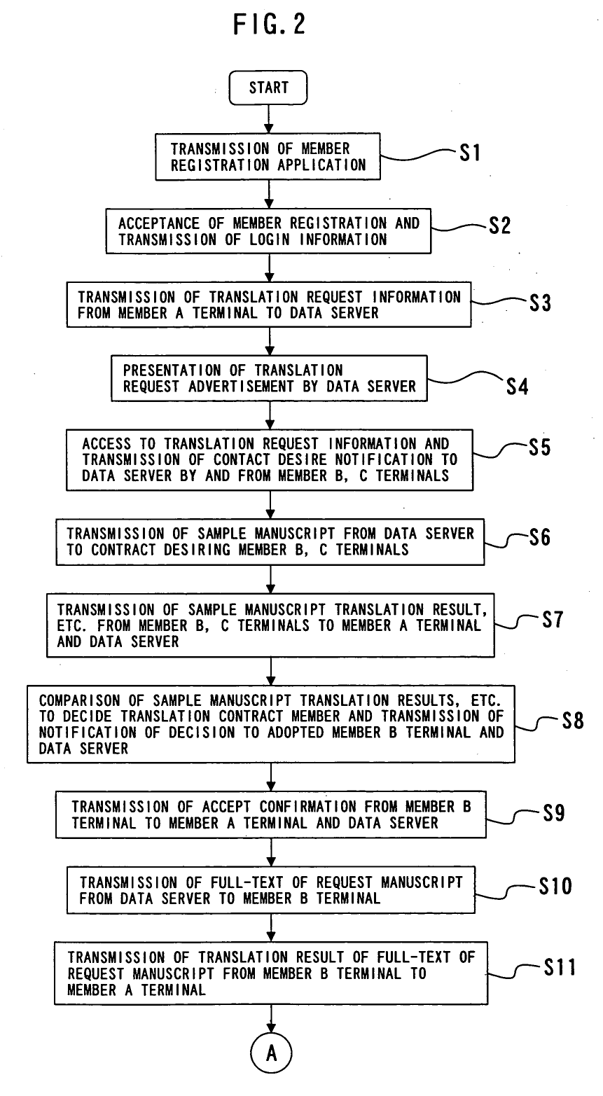

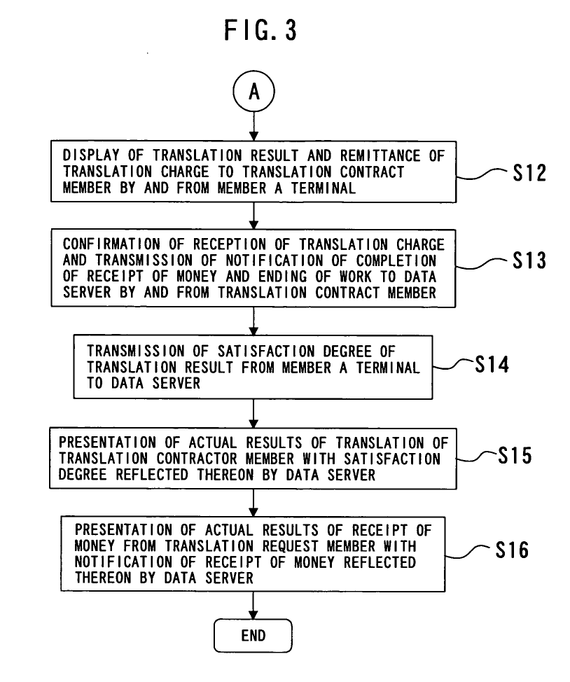

FIGS. 2 and 3 are flow charts illustrating operation of the translation service auction system of the embodiment of the present invention.

It is to be noted that, in the description given below, it is assumed that the member A is a client and the members B and C are contractors of translation.

Referring to FIGS. 2 and 3, the data server 1 first establishes a personal translation service site, and the terminals 2 to 4 which try to perform member registration application access the personal translation service site of the data server 1 to transmit the member registration application. The data server 1 receives the member registration applications and transmits a URL (Uniform Resource Locator) and login information to each of the terminals 2 to 4 which thus are each registered as a member (steps S1 and S2).

The member A who tries to request translation would access the personal translation service site of the data server 1 from the member A terminal 2 through the network 5 to input the login information, and thereafter, if the login information is authenticated by the data server 1, then the member A would send a manuscript, information of a language into which the manuscript is to be translated, a deadline and so forth (translation request information) to the data server 1 (step S3).

The data server 1 receives the translation request information from the member A terminal 2 and presents an advertisement (for example, “Translation request, Japanese=>Chinese, twenty sheets of 400-character manuscript paper, desired completion date: April 15”) of the requested translation on the personal translation service site. Then, the data server 1 stores the translation request information (step S4).

The members B and C who want to contract the translation would access the personal translation service site of the data server 1 from the individual terminals (the member B accesses from the member B terminal 3 and the member C accesses from the member C terminal 4) to input the login information, and thereafter, if the login information is authenticated by the data server 1, then the members B and C would read the translation request advertisement presented in the personal translation service site. Then, where the members B and C select contract of the translation work, the members B and C would issue a contract desire notification of the translation work to the data server 1 using an electronic mail or the like (step S5).

The data server 1 receives the contract desire notifications of the translation work and transmits the first paragraph of the manuscript stored in the data server 1 as a sample manuscript to the member terminals of the members B and C who desire contract of the translation work (step S6).

The member B terminal 3 and the member C terminal 4 display the first paragraph (sample manuscript) of the manuscript on individual screens. The members B and C would translate the sample manuscript and individually input a result of the translation of the sample manuscript, a general translation charge, and an expected completion date from the individual member terminals. Then, the individual member terminals 3 and 4 send individual replies including the inputted information to the member A terminal 2 and the data server 1 (step S7).

The member A terminal 2 displays the results of the translation of the sample manuscript, the general translation charges and the completion dates received individually from the member B terminal 3 and the member C terminal 4. The member A would compare the contents of the information received from the member terminals 3 and 4 to determine which member should be adopted (here, it is assumed that the member B is adopted). Then, the member A would issue an adoption notification to the terminal (member B terminal 3) of the adopted member B and the data server 1 (step S8).

The member B terminal 3 receives the adoption notification and originates a translation work ACCEPT confirmation to the member A terminal 2 and the data server 1 using an electronic mail or the like (step S9).

The data server 1 transmits the full-text of the manuscript to the terminal 3 of the adopted member B (step S10).

The member B would complete the requested translation work from the member A within the predetermined term and input a result of the entire translation to the member B terminal 3. The member B terminal 3 transmits the result of the translation to the member A terminal 2 (step A11).

The member A terminal 2 displays the result of the translation received from the member B terminal 3. The member A would check the contents of the translation result, and when the check is completed, the member A would remit a translation charge to the account designated by the member B (step S12).

The member B would confirm receipt of the money. The member B terminal 3 issues a notification of completion of receipt of money and ending of the work to the data server 1 (step S13).

The member A terminal 2 transmits a satisfaction degree of the translation contents of the transaction to the data server 1 (step S14).

The data server 1 receives the satisfaction degree from the member A terminal 2, reflects the satisfaction degree on stored actual results of translation of the translation contractor (updates the satisfaction degree every time a transaction ends) and presents the updated information on the personal translation service site. Therefore, any member who wants to request translation can access the data server 1 to refer to actual results of translation of such translation contractors to select a transaction contractor having a reliable translation skill and actual results (step S15).

Further, the data server 1 receives the notification of completion of receipt of money and ending of the working issued from the member B terminal 3, reflects the notification on stored actual results of receipt of money of the translation client (which are updated every time a transaction ends) and presents the updated information on the personal translation service site. Therefore, it is possible for any translation contractor to access the data server 1 to refer to the actual results of receipt of money of the translation clients thereby to find a translation client having some problem regarding payment in advance (step S16).

As described above, the translation client refers to results of translation of a sample manuscript to select a translation contractor and can request translation through a network even if the translation contractor lives at a remote place. Consequently, the translation client can enjoy an optimum translation service. Further, with increase of the number of members, the system manager can expect increase of the income of the membership fees and the income of advertisements.

In the translation service auction system of the embodiment of the present invention described above, the first paragraph of a requested manuscript of translation is used as a sample manuscript. However, as a modification to the embodiment described above, the system of the present invention may be configured such that, when the translation client transmits translation request information to the data server, the translation client attaches a manuscript different from the translation request information so that the different manuscript is used as a sample manuscript.

Further, in the translation service auction system of the embodiment of the present invention described above, member registration can be performed free of charge. However, as a modification to the embodiment described above, the member registration may require payment of a charge.

Furthermore, in the translation service auction system of the embodiment of the present invention described above, a translation request member pays the translation charge to a translation contract member. However, as a modification to the embodiment described above, the system of the present invention may be configured such that the system manager receives part of the translation charge paid from the translation request member to the translation contract member.

As another modification to the embodiment described above, the system of the present invention may be configured such that the system manager presents a PR advertisement of the translation contract member on the personal translation service site and imposes an advertisement charge on the translation contract member.

As a further modification to the present invention, the system of the present invention may be configured such that the system manager imposes an advertisement charge for a translation request advertisement presented on the personal translation service site of the data server on the translation request member.

In the embodiment of the present invention described above, a program and so forth for executing the processing operation of the translation service auction system of the present invention are recorded as data on a recording medium (not shown) such as a magnetic disk, an optical disk or the like of a computer, and the recorded data is read out and used in order to cause the translation service auction system to operate. The functions of the translation service auction system can be achieved by recording the data for causing the translation service auction system of the present invention to operate in advance on a recording medium and installing the data as described above.

While a preferred embodiment of the present invention has been described using specific terms, such description is for illustrative purposes only, and it is to be understood that changes and variations may be made without departing from the spirit or scope of the following claims.

What is claimed is:

1. A translation service auction system, comprising:
a data server;
a translation request member terminal connected to said data server through a network and including translation requesting means for transmitting translation request information to said data server through said network; and
a plurality of translation contract member terminals connected to said data server and said translation request member terminal through said network;
said data server including translation request information reception means for receiving the translation request information from said translation request member terminal and translation request advertisement presentation means for presenting a translation request advertisement on said network based on the received translation request information;
each of said translation contract member terminals including translation desire transmission means for referring to the translation request advertisement presented by said data server and transmitting a translation contract desire to said data server;
said data server further including translation desire reception means for receiving the translation contract desire from any of said translation contract member terminals and sample manuscript transmission means for transmitting a sample manuscript based on the translation request information to those of said translation contract member terminals from which the translation contract desire is received;
each of said translation contract member terminals further including sample translation means for receiving and translating the sample manuscript from said data server and transmitting a result of the translation of the sample manuscript to said translation request member terminal;
said translation request member terminal further including contract selection means for receiving the translation result of the sample manuscript from any of said translation contract member terminals, comparing the received translation results of the sample manuscript to determine a particular one of said translation contract member terminals which should be adopted, transmitting an adoption notification to the particular translation contract member terminal and transmitting a notification of the adopted translation contract member terminal to said data server;
said data server further including contract result reception means for receiving the notification of the adopted translation contract member terminal from said translation request member terminal and request manuscript transmission means for transmitting a request manuscript based on the translation request information to the adopted translation contract member terminal;
each of said translation contract member terminals further including request manuscript translation means for receiving the request manuscript from said data server and the adoption notification from said translation request member terminal, translating the request manuscript and transmitting a result of the translation of the request manuscript to said translation request member terminal;
said translation request member terminal further including translation result reception means for receiving the result of the translation of the request manuscript from the adopted translation contract member terminal.

2. A translation service auction system as claimed in claim 1, wherein said translation request member terminal further includes translation result transmission means for transmitting a satisfaction degree of the result of the translation of the requested manuscript to said data server, and said data server further includes presentation means for presenting the satisfaction degree of the result of the translation of the request manuscript transmitted from said translation request member terminal while reflecting the satisfaction degree in actual results of translation of the adopted translation contract member.

3. A translation service auction system as claimed in claim 2, wherein said contract selection means of said translation request member terminal compares the results of the translation of the sample manuscript and refers to the actual results of the translation of the pertaining translation contract members to decide a translation contract member terminal to be adopted.

4. A translation service auction system as claimed in claim 1, wherein each of said translation contract member terminals further includes money receipt completion notification means for transmitting a notification of completion of receipt of money from the translation request member to said data server, and said data server further includes presentation means for presenting the notification of completion of receipt of money from the translation request member received from the translation contract member terminal while reflecting the notification in actual results of receipt of money from said translation request member.

5. A translation service auction system as claimed in claim 4, wherein said translation contract member terminal further includes translation decision means for referring to the actual results of receipt of money of said translation request member to decide whether or not the translation request should be undertaken.

6. A translation service auction method for a translation service auction system wherein a data server, a translation request member terminal and a plurality of translation contract member terminals are connected to each other by a network, comprising:
a step performed by said translation request member terminal of transmitting translation request information to said data server;
a step performed by said data server of receiving the translation request information from said translation request member terminal and presenting translation request advertisement on said network;
a step performed by any of said translation contract member terminals of referring to the translation request information presented by said data server, transmitting a translation contract desire to said data server and transmitting a result of translation of a sample manuscript received from said data server to said translation request member terminal;
a step performed by said translation request member terminal of receiving and comparing the results of the translation of the sampling manuscript from the translation contract member terminals to decide a translation contract member terminal to be adopted and issuing an adoption notification to the adopted translation contract member terminal;
a step performed by the adopted translation contract member terminal of receiving the adoption notification from said translation request member terminal and transmitting a result of translation of the requested manuscript to said translation request member terminal; and
a step performed by said translation request member terminal of receiving the result of the translation of the requested manuscript from the adopted translation contract member terminal.

7. A translation service auction method as claimed in claim 6, wherein said translation request member terminal transmits a satisfaction degree of the result of the translation of the requested manuscript to said data server, and said data server presents the satisfaction degree of the result of the translation of the requested manuscript received from said translation request member terminal while reflecting the satisfaction degree in actual results of translation of the adopted translation contract member.

8. A translation service auction method as claimed in claim 7, wherein said translation request member terminal compares the results of the translation of the sample manuscript and refers to the actual results of translation of said translation contract member terminals to decide a translation contract member terminal to be adopted.

9. A translation service auction method as claimed in claim 6, wherein the adopted translation contract member terminal issues a notification of completion of receipt of money from the translation request member to said data server, and said data server presents the notification of completion of receipt of money from the translation request member received from the adopted translation contract member terminal while reflecting the notification in actual results of receipt of money from said translation request member.

10. A translation service auction method as claimed in claim 9, wherein said translation contract member terminal refers to the actual results of receipt of money of said translation request member to decide whether or not the translation request should be undertaken.

11. A translation service auction program for a translation service auction system wherein a data server, a translation request member terminal and a plurality of translation contract member terminals are connected to each other by a network, said translation service auction program causing a computer to implement:
a function of causing said translation request member terminal to transmit translation request information to said data server;
a function of causing said data server to receive the translation request information from said translation request member terminal;
a function of causing said data server to present translation request advertisement on said network;
a function of causing any of said translation contract member terminals to refer to the translation request information presented by said data server, transmit a translation contract desire to said data server and transmit a result of translation of a sample manuscript received from said data server to said translation request member terminal;
a function of causing said translation request member terminal to receive and compare the results of the translation of the sampling manuscript from the translation contract member terminals to decide a translation contract member terminal to be adopted;
a function of causing said translation request member terminal to issue an adoption notification to the adopted translation contract member terminal;
a function of causing the adopted translation contract member terminal to receive the adoption notification from said translation request member terminal and transmit a result of translation of the requested manuscript to said translation request member terminal; and
a function of causing said translation request member terminal to receive the result of the translation of the requested manuscript from the adopted translation contract member terminal.

12. A translation service auction program as claimed in claim 11, further causing said computer to implement a function of causing said translation request member terminal to transmit a satisfaction degree of the result of the translation of the requested manuscript to said data server, and a function of causing said data server to present the satisfaction degree of the result of the translation of the requested manuscript received from said translation request member terminal while reflecting the satisfaction degree in actual results of translation of the adopted translation contract member.

13. A translation service auction program as claimed in claim 12, further causing said computer to implement a function of causing said translation request member terminal to compare the results of the translation of the sample manuscript and refer to the actual results of translation of said translation contract member terminals to decide a translation contract member terminal to be adopted.

14. A translation service auction program as claimed in claim 11, further causing said computer to implement a function of causing the adopted translation contract member terminal to issue a notification of completion of receipt of money from the translation request member to said data server, and a function of causing said data server to present the notification of completion of receipt of money from the translation request member received from the adopted translation contract member terminal while reflecting the notification in actual results of receipt of money from said translation request member.

15. A translation service auction program as claimed in claim 14, further causing said computer to implement a function of causing said translation contract member terminal to refer to the actual results of receipt of money of said translation request member to decide whether or not the translation request should be undertaken.
